(19) United States
(12) Patent Application Publication
(10) Pub. No.: US 2024/0100806 A1
(43) Pub. Date: Mar. 28, 2024

(54) Surfacing Device Tether End Component

(71) Applicant: Ben Player, Avalon (AU)

(72) Inventor: Ben Player, Avalon (AU)

(21) Appl. No.: 18/276,050

(22) PCT Filed: Feb. 8, 2022
(86) PCT No.: PCT/AU2022/050066

§ 371 Date: Aug. 7, 2023

(30) Foreign Application Priority Data
Feb. 8, 2021 (AU) 2021900288
Aug. 24, 2021 (AU) 2021107003

(51) Int. Cl. B32B 5/18; B29C 65/14; B32B 27/06; B63B 32/73

(52) U.S. Cl. CPC B32B 5/18; B29C 65/1403; B32B 27/065; B63B 32/73

(57) ABSTRACT

The present invention relates to, in a first aspect, a surfing tether end component comprising an end component body having one or more end component body layers, a tether connector for connecting the surfing tether end component to a surfing device tether, and a fastening means. A second and third aspect, comprising methods of forming a surfing tether end component, are also provided.

### PRIORITY DETAILS

The present application claims priority from AU 2021900288, filed in Australia on 8 Feb. 2021, and AU 2021107003, filed in Australia on 17 Nov. 2021, the entirety of both of which are incorporated herein by reference.

### TECHNICAL FIELD

The present invention relates generally to the field of surfing devices, and more particularly to the field of end components for surfing device tethers.

### BACKGROUND

Surfing and therefore surfing devices are increasing in consumer demand and usage. Surfing devices are fabricated in many ways and come in multiple shapes and sizes that are commonly known as surfboards, boogie boards, body boards, soft surf boards, foam surfboards, softies, foamies, etcetera, and can be ridden in many ways, such as laying on, or kneeling on, or standing on. There have also been many advancements in performance enhancing features for surfing devices such as strengthening apparatuses, fins, plugs and tethers.

Surfing tether apparatuses that attach to a surfing device were originally fabricated from rope or cord, but in recent years, there have been advancements in design and materials for surfboard tethers in an effort to fabricate a surfboard tether that is lightweight, durable and comfortable. With reference to prior art FIG. 1, most modern prior art for surfing device tether end components P-10 are comprised of three main components, being the end component body P-12, one or more fastening means P-14 and a prior art connector P-16, which receives a surfing device tether P-18. The elements of the end component P-10 are fixed together by stitching P-20, depicted in a magnified view in Inset 1A. Prior art end components P-10 were typically comprised of multiple materials such as hook-and-loop fasteners commonly made from nylon; webbing that was commonly made from polyester; and neoprene. The method of fabrication for the prior art end component P-10 consisted of assembling the multiple layers along a vertical axis and stitching the multiple layers together on the flat surface with the aid of a sewing machine, thus joining all the layers.

The use of different materials, and sewing the various components together, means that the formed cuff P-10 lacks flexibility. Additionally, the stitches can induce localised weaknesses in the cuff, making it more likely to snap or otherwise fail.

Additionally, although few variations for surfing tether apparatuses exist, and are well documented as prior art, all prior art share negative aspects of aesthetic limitations as a result of materials available, being vulnerable to failure as a result of materials and fabrication methods, or lack of performance as a result of manufacturing limitations.

There is therefore a need to provide an improved surfing tether end component, and/or to reduce or at least ameliorate the deficiencies of the prior art.

### DISCLOSURE OF THE INVENTION

In a first aspect, the present invention relates to a surfing tether end component comprising an end component body having one or more end component body layers, a tether connector for connecting the surfing tether end component to a surfing device tether, and a fastening means.

In an embodiment one or more of the tether connector and the fastening means are moulded from, onto or into one of the one or more end component body layers.

In an embodiment at least one adjacent pair of the end component body, the one or more layers of the end component body, the tether connector and the fastening means are at least partially affixed to one another by being bonded thereto.

In an embodiment at least a portion of at least one of the one or more end component body layers comprises at least one polymer selected from a single polymer class, being a contacting portion thereof, at least one of the fastening means and the tether connector comprise a contacting surface comprised of at least one polymer selected from the single polymer class, and the contacting surface contacts against and bonds to the contacting portion.

In an embodiment the contacting surface is thermally bonded to the contacting portion. In an embodiment the contacting surface is welded to the contacting portion. In an embodiment the thermal bond is a molecular or intermolecular bond.

In an embodiment the contacting surface and the contacting portion are fused together. In an embodiment the contacting surface and the contacting portion are thermally bonded together through an internal heat welding process or an external heat welding process. In an embodiment both internal and external heat welding processes are used to thermally bond the contacting surface and the contacting portion together.

In an embodiment the thermal bond is at least partially formed via internal heat welding process, and the internal heat welding process is either an electromagnetic welding process or a mechanical welding process. In an embodiment both an electromagnetic welding process and a mechanical welding process are used.

In an embodiment the thermal bond is at least partially formed via external heat welding process and the external heat welding process is a thermal welding process.

In an embodiment the single polymer class is one of the set of classes comprising thermoplastics, thermoplastic elastomers, thermosets, polypropylenes, polyketones, polyethylenes, polyurethanes, vinyls, polyolefins, or suitable derivatives thereof. In an embodiment the contacting portion is substantially formed from a single polymer. In an embodiment the contacting surface is substantially formed from the same single polymer as the contacting portion.

In an embodiment end component body comprises more than one end component body layer, and the contacting portion is provided by an outermost end component body layer.

In an embodiment the end component body comprises more than one end component body layer, and at least one end component body layer is arranged over the end component body layer providing the contacting portion so as to enclose, within the end component body, at least a portion of the at least one of the fastening means and the tether connector having the contacting surface bonded to the contacting portion.

In an embodiment the end component body comprises more than one end component body layer, each end component body layer extending for at least a portion of a length of the end component body, and at least two adjacent end component body layers are formed of at least one polymer selected from the single polymer class and are at least partially affixed to one another by thermal bonding.

In an embodiment the surfing tether end component further comprises a secondary element bonded to, or moulded from, onto or into the one or more end component body layers.

In an embodiment the surfing tether end component is configured to attach the tether to a user's limb, the tether end component body is configured to encircle the user's limb and the fastening means comprises a first fastening structure and a second fastening structure arranged to releasably engage with one another when the user's limb is encircled by the tether end component body.

In an embodiment at least one of the at least two adjacent end component body layers comprises a cushioning layer. In an embodiment wherein at least one of the at least two adjacent end component body layers is an expanded polymer foam layer. In an embodiment at least one of the at least two adjacent end component body layers is configured to retain a curved shape memory determined by a curve of the surfer's limb. In an embodiment the expanded polymer foam layer is the at least one of the at least two adjacent end component body layers that is configured to retain the curved shape memory.

In an embodiment the surfing tether end component is configured to attach the tether to a surfing device and the fastening means is configured to engage with a tether-receiving fixture on the surfing device.

In an embodiment the surfing tether end component does not comprise adhesives, additional cross-link polymers or any other additional affixing means between the adjacent two of the one or more end component body layers, the tether connector and the fastening means that are affixed to one another by being bonded together.

A second aspect of the invention may lie in a method of fabricating a surfing tether end component comprising an end component body having one or more end component body layers, a fastening means and a tether connector, comprising the steps of:
1) forming one or more end component body layers;
2) arranging the one or more end component body layers into a desired configuration to form the end component body;
3) if the end component body comprises more than one end component body layer, attaching the plurality of end component body layers together to form the end component body;
4) arranging a tether connector adjacent to a layer of the end component body;
5) arranging a fastening means; and
6) affixing the tether connector and fastening means to the end component body;
wherein at least one adjacent pair of the one or more end component body layers, the end component body, the tether connector and fastening means are at least partially affixed to one another by bonding thereto.

In an embodiment the end component body comprises more than one end component body layer, and either or both of Steps (IV) & (V) are executed before Step (III), such that, if Step (IV) is executed before Step (III), Step (III) comprises affixing the tether connector to the adjacent end component body layer and attaching the plurality of end component body layers together to form the end component body, and/or if Step (V) is executed before Step (III), Step (III) comprises affixing the fastening means to the respective adjacent end component body layer or layers and attaching the plurality of end component body layers together to form the end component body, and Step (VI) comprises affixing any of the as-yet-unaffixed of the tether connector and the fastening means to the end component body.

In an embodiment wherein both Step (IV) and Step (V) are executed before Step (III), Steps (III) and (VI) are executed substantially simultaneously.

In an embodiment at least a portion of at least one of the one or more end component body layers comprises at least one polymer selected from a single polymer class, being a contacting portion thereof, at least one of the fastening means and the tether connector comprise a contacting surface comprised of at least one polymer selected from the single polymer class, and the contacting surface contacts against and bonds to the contacting portion.

In an embodiment the end component body comprises more than one end component body layer, and the contacting portion is provided by an outermost end component body layer.

In an embodiment the end component body comprises more than one end component body layer, and at least one end component body layer is arranged over the end component body layer providing the contacting portion so as to enclose, within the end component body, at least a portion of the at least one of the fastening means and the tether connector having the contacting surface bonded to the contacting portion.

In an embodiment the at least partial attachment by bonding is at least partial attachment by a thermal bond. In an embodiment the contacting surface is welded to the contacting portion. In an embodiment the thermal bond is a molecular or intermolecular bond. In an embodiment the contacting surface and the contacting portion are fused together. In an embodiment the contacting surface and the contacting portion are thermally bonded together through an internal heat welding process or an external heat welding process. In an embodiment both internal and external heat welding processes are used to thermally bond the contacting surface and the contacting portion together.

In an embodiment the thermal bond is at least partially formed via internal heat welding process, and the internal heat welding process is either an electromagnetic welding process or a mechanical welding process. In an embodiment both an electromagnetic welding process and a mechanical welding process are used.

In an embodiment the thermal bond is at least partially formed via external heat welding process, and the external heat welding process is a thermal welding process.

In an embodiment wherein the tether end component body is configured to encircle the user's limb, the fastening means comprises a first fastening structure and a second fastening structure arranged to releasably engage with one another when the user's limb is encircled by the tether end component body.

In an embodiment wherein the end component body comprises more than one end component body layer, at least one of the end component body layers comprises an expanded foam layer that is at least partially attached to an adjacent end component body layer by thermal bonding.

In an embodiment the expanded foam layer is configured to retain a curved shape memory, the method further comprises the step of thermally moulding the expanded foam layer so as to thermally set the curved shape memory thereinto, and the step of thermally moulding the expanded foam layer is executed prior to Step (II).

In an embodiment the fastening means is configured to engage with a tether-receiving fixture on the surfing device.

In an embodiment the surfing tether end component does not comprise adhesives, additional cross-link polymers or any other additional affixing means between the adjacent two of the one or more end component body layers, the tether connector, and the fastening means that are affixed to one another by being bonded together.

A third aspect of the invention may lie in a method of fabricating a surfing tether end component comprising an end component body having one or more end component body layers, a fastening means and a tether connector, wherein at least one of the fastening means and the tether connector are moulded from, onto or into the end component body, the method comprising the steps of:
1) Inserting a polymer of a single polymer class into a mould having a cavity with a desired shape comprising at least one end component body layer and one or more of the tether connector and the fastening means;
2) moulding the polymer into a moulding having the desired shape; and
3) ejecting the moulding from the mould;
   wherein the moulding comprises the at least one end component body layer and the one or more of the tether connector and/or the fastening means having unitary construction.

In an embodiment the method further comprises the steps of:
4) inserting the moulding into a secondary mould, along with additional polymer of the single polymer class, the secondary mould having a cavity with a further desired cavity shape comprising the moulding and a further one or more of the tether connector and the fastening means excluding those already formed as a part of the moulding;
5) moulding or over-moulding the polymer onto or into the moulding, forming a further moulding having the further desired shape; and
6) ejecting the further moulding from the secondary mould.

In an embodiment the moulding or further moulding is used as an end component body layer in a method of an embodiment of the second aspect of the invention.

Further embodiments may be disclosed herein or may become apparent to the skilled person through the disclosure. These and other embodiments are considered to fall within the scope of the invention as claimed.

### DESCRIPTION OF FIGURES

Embodiments of the present invention will now be described in relation to figures, wherein:

FIG. 1 and Inset 1A depict a prior art surfing tether end component;

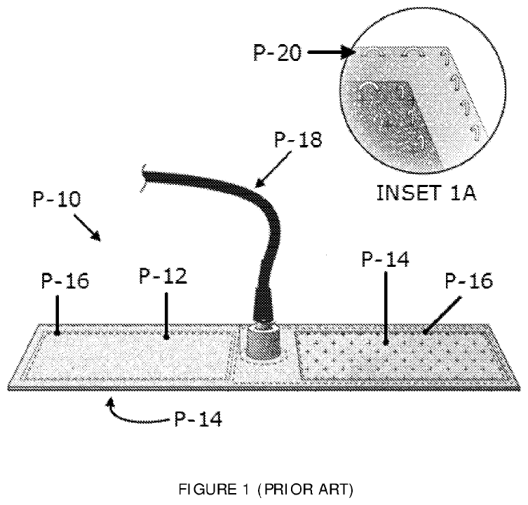

FIG. 2 depicts two embodiments of a surfing tether end component of the present invention;

FIG. 3 depicts a cross-section of an embodiment of the present invention having multiple body layers;

FIGS. 4-6 depict layering and construction arrangements;

FIGS. 7 & 8 depict embodiments of the method of the second aspect of the invention; and

FIGS. 9 & 10 depict embodiments of the method of the third aspect of the invention.

### DEFINITIONS

As used herein, the term ‘bond’ refers to two or more elements that are securely affixed to one another through chemical, thermal or pressure-driven mechanisms, and excludes purely physical mechanisms such as riveting or stitching.

As used herein, “consist essentially” should not be strictly interpreted so as to preclude the presence of trace other materials that do not otherwise increase the complexity of recycling of an element or article in question. Rather, “consist essentially” is to be understood to mean that the element or article in question either does not comprise materials other than the identified material or materials, or said other materials are present in negligible amounts. Similarly, “negligible” is to be interpreted to mean that any other materials in the composition of the element or article in question are present in fractions too small to materially alter either the element or article in question, or its ability to be recycled at end-of-life.

### DETAILED DESCRIPTION OF PREFERRED EMBODIMENTS

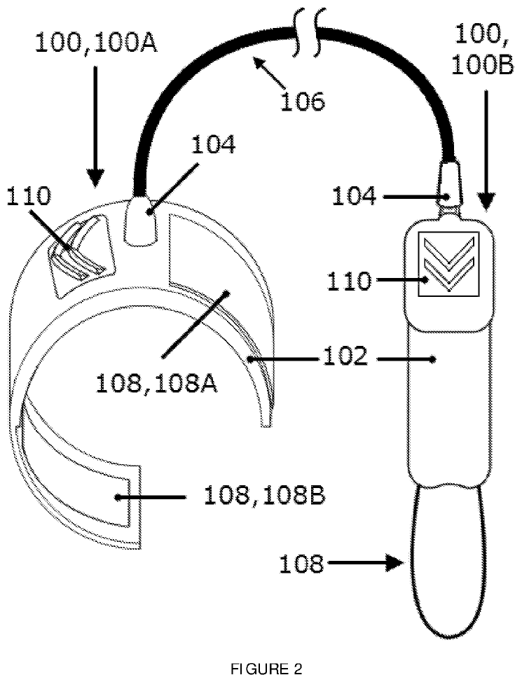

In a first aspect and with reference to FIG. 2, the present invention relates to surfing tether end components, comprising an end component body 102, a tether connector 104 for connecting the surfing tether end component 100 to a surfing device tether 106, and a fastening means 108 to fasten the surfing tether end component to either a user's limb or a surfing device.

In an embodiment, the tether end component 100 may be a tether end component 100A that attaches the tether 106 to a surfer's limb (not shown), thereby tethering together the surfer and the surfing device. Such an embodiment of a tether end component 100A is typically referred to as a “cuff” or “tether cuff”. In such an embodiment, the fastening means 108 may comprise a first fastening structure 108A and a second fastening structure 108B arranged to releasably engage with one another so as to fasten the surfing tether end component 100 about the user's limb when the user's limb is encircled by the tether end component body 102. In an embodiment, the first and second fastening structures 108A,108B may comprise a press-stud pair, a button and button-hole, hook-and-loop fasteners or any other suitable fastening means known in the art.

In an alternate embodiment, the tether end component 100 may be a tether end component 100B that attaches the tether 106 to the surfing device (not shown). Such an embodiment of a tether end component 100B is often referred to as a “rail-saver”. In such an embodiment, the fastening means 108 may comprise a loop, clip or carabiner-style fastener that extends from the end component body 102 and attaches to a fixture on a surfing device (not shown).

As used herein, reference numeral 100 is used to refer to both forms of the tether end component 100A,100B. Although the two tether end components 100A,100B have different appearances, their functional properties are substantially similar to one another. Unless otherwise specifically noted, both of the tether end components 100A,100B may embody any embodiments of the present invention.

In an embodiment, the surfing tether end component may further comprise a secondary element 110, such as a puller, a buckle loop or a decorative element. FIG. 2 depicts an example secondary element 110 as a decorative element, but the skilled person will appreciate that this is merely an example and not to be construed as explicitly limiting.

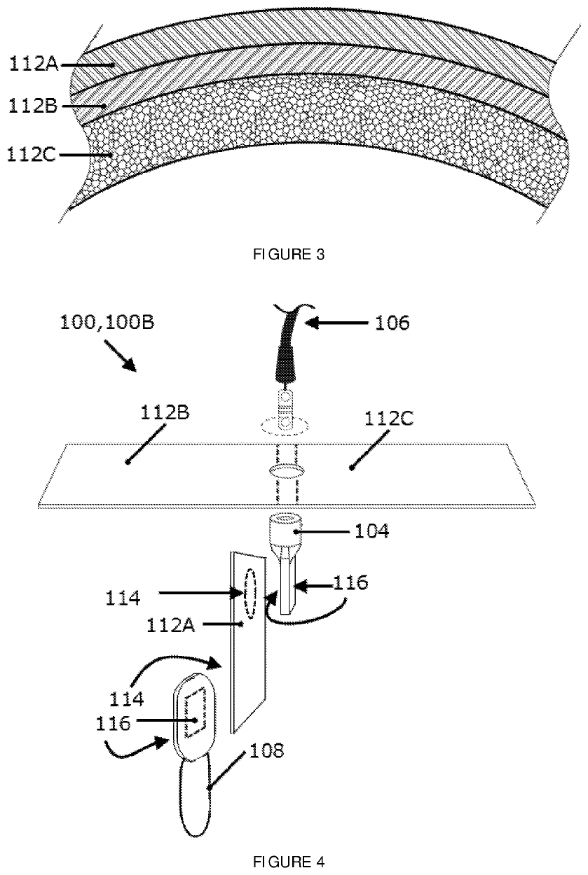

In an embodiment, the end component body 102 may comprise one or more end component body layers. In a further embodiment, the end component body 102 may comprise a single end component body layer. In an alternate further embodiment and with reference to FIG. 3, the end component body may comprise a plurality of end component body layers 112A,112B,112C. The end component body layers 112A,112B,112C may each extend for a full length and/or a full width of the end component body. Alternatively, one or more of the plurality of end component body layers 112A,112B,112C may only extend for a portion of the length and/or width of the end component body. The person skilled in the art will appreciate that a reference to end component body layers 112A,112B,112C in describing embodiments of the invention is exemplary only and does not exclude an embodiment an end component body comprising a single end component body layer, two end component body layers, or more than three end component body layers, from the scope thereof, unless it is otherwise explicitly specified for (and therefore explicitly limited to) a particular, specific embodiment.

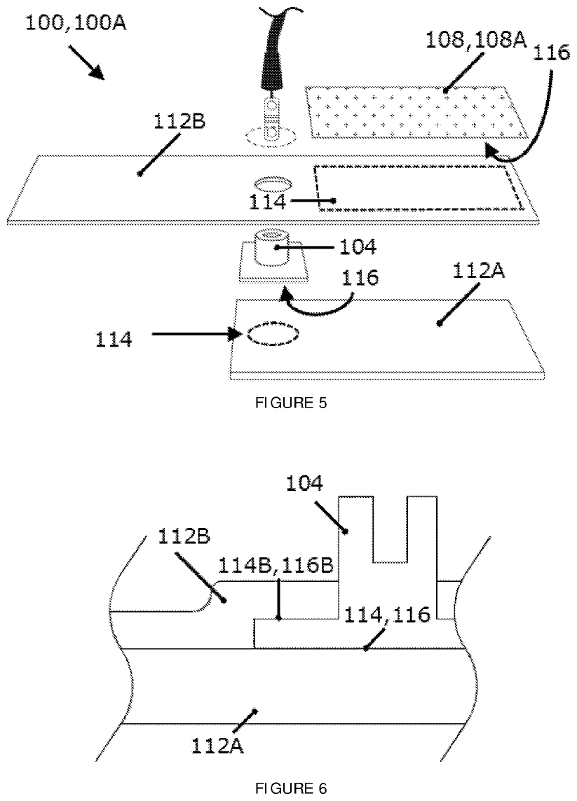

With reference to FIG. 4, in some embodiments, a single ‘sheet’ may fold to form two layers. With specific reference to FIG. 5, body layers 112B and 112C are formed by a single ‘sheet’, folding along the vertical dashed lines.

### Bonded End Component Elements

In an embodiment, any adjacent two of the end component body 102, the one or more layers of the end component body 112A,112B,112C, the tether connector 104, the fastening means 108 and the secondary element 110 (if present) may be at least partially affixed to one another by being bonded thereto.

In one embodiment, the adjacent two elements that are at least partially affixed to one another by being bonded together may be fully affixed through bonding, and do not comprise any additional affixing means such as rivets, stitching or adhesives or others known in the art.

In an embodiment wherein the end component body 102 comprises more than one end component body layer 112A,112B,112C, each end component body layer may extend for at least a portion of a length of the end component body. In a further embodiment, at least two adjacent end component body layers 112A,112B,1120 may be at least partially affixed to one another by thermal bonding. In a further embodiment, at least one of the at least two adjacent of end component body layers 112A,112B,112C may comprise a cushioning layer.

In an embodiment and with reference to FIGS. 4 & 5, at least a portion of one of the one or more end component body layers 112A,112B,112C may be a contacting portion 114. In such an embodiment, at least one of the fastening means 108, the tether connector 104 and the secondary element 110 (if present) comprise a contacting surface 116 adapted to contact against and bond to or with the contacting portion 114. In an embodiment, the contacting surface may be located on a surface of the tether connector 104. In an embodiment, the contacting surface may be located on a surface of the secondary element 110, if present.

With specific reference to FIG. 5, in an embodiment wherein the tether connector end component 100A is to attach the tether 106 to a surfer's limb, the contacting surface 116 may be on either or both of the first and second fastening structures 108A,108B of the fastening means 108.

In a further embodiment, the end component body 102 may comprise multiple contacting portions 114, on either the same end component body layer or separate ones. In such an embodiment, more than one of the fastening means 108 (or the first and second fastening structures 108A,108B as appropriate), tether connector 104 and the secondary element 110 (if present) may comprise contacting surfaces and may be affixed to the end component body by bonding.

In an embodiment wherein the end component body comprises more than one end component body layer, the contacting portion 114 may be provided by an outermost end component body layer. In an alternative embodiment, at least one end component body layer 112B is arranged over the end component body layer 112A providing the contacting portion 114 so as to enclose, within the end component body 102, at least a portion of the at least one of the fastening means 108, the secondary element 110 (if present) and the tether connector 104 having the contacting surface 116 bonded to the contacting portion 114. FIG. 4 in particular depicts both an example embodiment wherein the contacting portion 114 is present on an outermost layer (end component body layer 112B in the depicted example), and an embodiment wherein end component body layer 112B is layered over the bonded contacting surface 116 and an additional contacting portion 114 present on end component body layer 112A. This layering may provide a more secure construction of the surfing tether end component 100. The skilled person will appreciate that denoting the end component body layers with reference numerals 112A & 112B is for explanatory purposes only and is intended to illustrate that a contacting portion 114 may be provided on various end component body layers 112A,112B,112C.

As depicted in the figures, some components such as the tether connector 104 and/or fastening means 108 may comprise contacting surfaces 116 on multiple sides. In a further embodiment and with reference to FIGS. 4-6, the further end component body layer 112B that is layered over the bonded contacting portion 114 and contacting surface 116 may in turn have a further contacting portion 114B that bonds to a further contacting surface 116B on whichever of the fastening means 108, the secondary element 110 (if present) and the tether connector 104 comprises the contacting surface 116.

### Construction Materials

In an embodiment, at least the contacting portion 114 of the end component body layer 112A,112B,112C may be comprised of at least one polymer selected from a single polymer class. In such an embodiment, at least one of the fastening means 108, the secondary element 110 (if present) and the tether connector 104 comprise a contacting surface 116 that is comprised of at least one polymer selected from the same single polymer class as that of the contacting portion 114.

In an embodiment wherein the end component body comprises more than one end component body layer 112A,112B,112C and with reference to FIG. 2, at least two adjacent end component body layers 112A,112B may be each formed of at least one polymer selected from the single polymer class.

The skilled person will appreciate that there are many known polymers, and that they may be classified in various manners depending upon classification criteria. Polymers may, for example, be classified based upon source material (natural, synthetic or semi-synthetic); monomer chain structure (linear, cross-linked or branched-chain); polymerisation method (addition or condensation); monomer type (homomeric or copolymeric); and present molecular forces (elastomers, fibrous, thermoplastics or thermosetting polymers). As used herein, polymer class refers to groups of polymers that are able to be recycled through the same recycling process or substantially similar recycling processes.

In an embodiment, the polymers may be selected from groups such as thermoplastics, thermoplastic elastomers, thermosets and recyclable thermoset polymers. In an embodiment, the polymers may be selected from particular groups such as polyketones, polyesters, polyurethanes, polyolefins, vinyls, or suitable derivatives thereof. In an embodiment, one or more of the selected polymers may be co-polymers. In a further embodiment, the co-polymers may be linear co-polymers (including alternating, statistical and block co-polymers) or branched co-polymers (including grafted or star-shaped branched co-polymers, or branched co-polymers having other architectures). In an alternate embodiment, each of the selected polymers may be homomeric.

In an embodiment, the polyurethane may be a thermal polyurethane. In an embodiment, the vinyl may be a vinyl acetate, a vinyl chloride, a polypropylene, a polystyrene, a polyethylene, or a polyacrylonitrile. In an embodiment, the polymer may be a co-polymer of ethylene and vinyl acetate, typically referred to as polyethylene-vinyl acetate (EVA), or a triple co-polymer (or terpolymer) formed by polymerisation of styrene and acrylonitrile in the presence of polybutadiene, typically referred to as acrylonitrile butadiene styrene (ABS).

It is considered that, by providing affixing means (e.g. the contacting portion 114 and contacting surface 116) that are at least substantially comprised of similar materials (such as polymers selected from the same polymer class), efficiency of production may be improved. Furthermore, the use of additional affixing means may be reduced or eliminated, as bonding between the elements comprised of substantially similar materials may be promoted. Additionally, upon an embodiment of the surfing tether end component 100 reaching end-of-life, the ability for and/or efficiency of the surfing tether end component 100 to be recycled may be improved as it is not required to separate the elements into a plurality of recycling streams directed to separate plastic classes, types or categories, and the single polymer class is selected from polymer classes that are able to be recycled.

In at least one further embodiment, at least partially forming the one or more of the tether connector 104, the secondary element 110 (if present), and the fastening means 108 from polymers selected from the same polymer class as the end component body layers 112A,112B,112C, may promote thermal, molecular or interfacial bonding therebetween.

In a further embodiment, the end component body layer 112 and/or one or more of the tether connector 104, the secondary element 110 (if present), and the fastening means 108 may each consist essentially of at least one polymer selected from the single class of polymers. This may be the same at least one polymer, or each may be formed from different polymers selected from the single class of polymers. This may further enhance or promote the ability of the contacting portion 114 and the contacting surface 116 to thermally bond to one another, and may also promote or enhance the recyclability of the surfing tether end component 100 at end-of-life. In a further embodiment, the surfing tether end component 100 as a whole may consist essentially of at least one polymer selected from the single polymer class.

In a further embodiment, the contacting portion 114 is substantially formed from a single polymer selected from the single class of polymers. In a further embodiment, the contacting surface 116 is substantially formed from the same single polymer as the contacting portion 114. In a further embodiment, the end component body layer 112 and/or one or more of the tether connector 104, the secondary element 110 (if present), the fastening means 108, or even surfing tether end component 100 as a whole, may consist essentially of a single polymer selected from the single class of polymers. This may be the same single polymer, or each may be formed from different polymers selected from the single class of polymers.

Some other materials that may be present are: dyes or other colouring agents; trace amounts of polymers from a different polymer class; remnants from the formation of foamable polymer beads, such as foaming agents; additives utilised to promote expansion, sintering and/or thermal bonding of the foamable polymer beads to one another to form, for example, an end component body layer 112 comprised thereof; and any other trace contaminants or additives that the person skilled in the art would reasonably anticipate as being likely to be present in elements or articles formed from polymers that are essentialy selected from a single polymer class without affecting the structure, functionality or recyclability of the element or article. The person skilled in the art will understand that the preceding list is not exhaustive.

In an embodiment wherein at least two adjacent end component body layers 112A,112B,112C are bonded to one another, at least one thereof may comprise an expanded polymer foam layer. In a further embodiment, the expanded polymer foam layer may form a cushioning layer.

In an embodiment wherein at least two adjacent end component body layers 112A,112B,112C are bonded to one another, at least one of the at least two adjacent end component body layers may be configured to retain a curved shape memory determined by a curve of the surfer's limb. In a further embodiment, the end component body 102 may comprise an expanded polymer foam layer that is configured to retain the curved shape memory. Alternatively, the curved shape memory may be provided by another end component body layer 112A,112B,112C that is formed of a polymer capable of exhibiting shape memory properties.

### Bonding Mechanisms

In an embodiment, the contacting surface 116 and contacting portion 114 are adapted to contact against and bond to one another. In an embodiment, the bonding may be a thermal bond therebetween.

In an embodiment, the thermal bond may be formed by at least partial melting of either or both of the contacting portion 114 and contacting surface 116. In an embodiment, the thermal bond may comprise a fusion between the contacting surface 116 and contacting portion 114, wherein the contacting portion and contacting surface are contacted against one another either or both are at least partially molten and subsequently allowed to re-solidify. In an embodiment, the thermal bond may comprise the contacting surface 116 and contacting portion 114 being welded to one another through one or more polymer welding methods known in the art. In an embodiment, the thermal bond may comprise formation of either molecular or intermolecular bonds between some or all of the polymers of the contacting surface 116 and the polymers of the contacting portion 114. In some embodiments, a bonding agent may be used to promote or enable formation of the bond between the contacting surface 116 and contacting portion 114. In some alternate embodiments, the bond between the contacting surface 116 and contacting portion 114 may be a direct interfacial bond, wherein the contacting surface 116 and contacting portion 114 are in direct contact with one another (i.e. with no additional substances between the contacting surface 116 and contacting portion 114) prior to, or as part of, the bonding process.

In an embodiment, the contacting surface and the contacting portion are thermally bonded together through either or both of an internal heat welding process or an external heat welding process. In a further embodiment wherein the thermal bond is at least partially formed via internal heat welding process, the internal heat welding process is either an electromagnetic welding process or a mechanical welding process. The electromagnetic welding process may be selected from resistance welding, induction welding, dielectric welding and microwave welding. The mechanical welding process may be selected from spin welding, stir welding, vibration welding and ultrasonic welding.

In a further embodiment wherein the thermal bond is at least partially formed via external heat welding process, the external heat welding process is a thermal welding process. The thermal welding process may be selected from hot gas welding, hot wedge welding, extrusion welding, hot plate welding, infrared welding and laser welding.

In a further embodiment, the surfing tether end component 100 does not comprise adhesives, cross-link polymers, rivets, stitching, or other affixing means known in the art between the adjacent two of the one or more end component body layers 112A,112B,112C, the tether connector 104, and the fastening means 108 that are affixed to one another by being bonded together. This may enable reduction in the number of different materials present within the surfing tether end component 100, and may improve the ability of the surfing tether end component to be recycled at end-of-life.

### Moulded End Component Elements

In an embodiment, at least one of the tether connector 104, the secondary element 110 (if present), and the fastening means 108 may be moulded from, onto or into the end component body 102. The tether connector 104, the secondary element 110 (if present), and/or the fastening means 108 may be moulded from, onto or into one of the end component body layers, and one or more further end component body layers may be layered over or underneath. The skilled person will appreciate that if more than one of the tether connector 104, the secondary element 110 (if present) and the fastening means 108 are moulded into, onto or from a layer of the end component body 102, then each may be moulded into or from the same end component body layer or into different end component body layers without departing from the scope of the present invention.

In an embodiment, the surfing tether end component may comprise one or more elements (tether connector 104, fastening means 108, secondary element 110) that are moulded from, onto or into one of the end component body layers, and a further one or more elements that are affixed to one of the end component body layers by being bonded thereto. In a further embodiment, the further one or more elements may be bonded to the end component body layer in a manner described in one or more of the above embodiments.

### Formation Method—Attachment

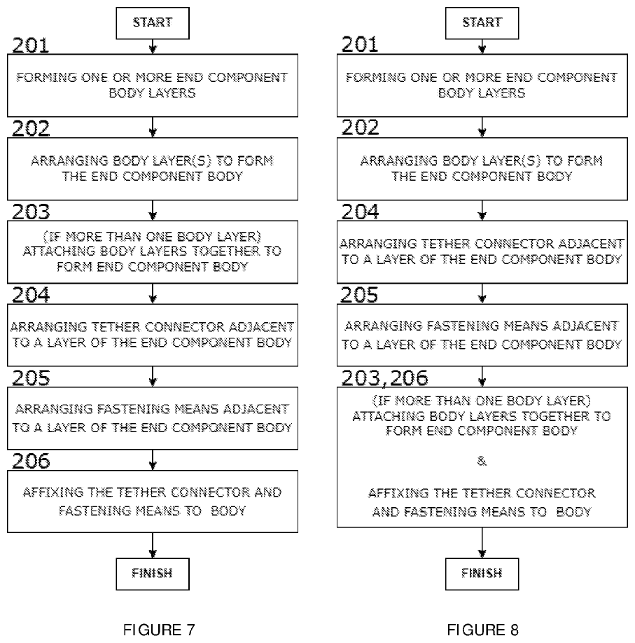

A second aspect of the present invention may lie in a method of fabricating a surfing tether end component comprising an end component body having one or more end component body layers, a fastening means and a tether connector. In an embodiment and with reference to FIG. 7, the method may comprise the steps of:
201) forming one or more end component body layers;
202) arranging the one or more end component body layers into a desired configuration to form the end component body;
203) if the end component body comprises more than one end component body layer, attaching the plurality of end component body layers together to form the end component body;
204) arranging a tether connector adjacent to a layer of the end component body;
205) arranging a fastening means adjacent to a layer of the end component body; and
206) affixing the tether connector, and fastening means to the end component body.

In an embodiment, at least one adjacent pair of the one or more end component body layers, the end component body, the tether connector, and the fastening means are at least partially affixed to one another by bonding thereto. The bonding may be through any of the bonding mechanisms described above in relation to the first aspect of the present invention.

In a further embodiment wherein the end component body comprises more than one end component body layer, either or both of Steps 204 & 205 may be executed before Step 203. In such an embodiment, the tether connector and/or the fastening means may be arranged adjacent to their respective receiving end component body layers so that step 203 comprises affixing the tether connector, and/or the fastening means to the respective end component body layer or layers as well as forming the end component body, and step 206 comprises affixing the remaining elements to the end component body.

In a further embodiment wherein both of Steps 204 & 205 are executed before Step 203 and with reference to FIG. 8, steps 203 and 206 may be executed substantially simultaneously, in that the formation of the end component body and the affixation of the tether connector, and the fastening means to the respective end component body layer or layers occurs in a single bonding step. In such an embodiment, the method may be as follows:
201) forming one or more end component body layers;
202) arranging the one or more end component body layers into a desired configuration to form the end component body;
204) arranging a tether connector adjacent to a layer of the end component body;
205) arranging a fastening means; and
203) & 206) simultaneously forming the end component body and affixing the tether connector, and fastening means to respective adjacent layer or layers of the end component body.

In an embodiment, at least a portion of at least one of the one or more end component body layers comprises at least one polymer selected from a single polymer class, being a contacting portion thereof. In an embodiment, at least one of the fastening means and the tether connector comprise a contacting surface comprised of at least one polymer selected from the single polymer class, and the contacting surface contacts against and bonds to the contacting portion. In a further embodiment, the contacting surface and/or contacting portion may be a contacting surface 116 or contacting portion 114 of an embodiment of the first aspect of the invention.

In an embodiment wherein the end component body comprises more than one end component body layer, the contacting portion may be provided by an outermost end component body layer.

In an alternative embodiment wherein the end component body comprises more than one end component body layer, at least one end component body layer may be arranged over the end component body layer providing the contacting portion with the contacting surface positioned therebetween, so as to enclose, within the end component body, at least a portion of the at least one of the fastening means and the tether connector having the contacting surface bonded to the contacting portion. In a further embodiment, the portion of the element so enclosed may be contacted by and bond with both of the end component body layers. This layering may provide a more secure construction of the surfing tether end component.

In an embodiment, at least partial attachment by bonding may be at least partial attachment by a thermal bond as previously described in relation to the first aspect of the invention. The thermal bond may be a molecular or intermolecular bond, or may be a direct bond, direct thermal bond or direct molecular or intermolecular bond, also as previously described. Similarly, the bond may be formed through any of the mechanisms, including internal and/or external heat welding processes (or combinations thereof) as previously described in relation to one or more embodiments of the first aspect of the invention.

In an embodiment wherein the end component body comprises more than one end component body layer, at least one of the end component body layers may comprise an expanded foam layer that is at least partially attached to an adjacent end component body layer by thermal bonding. This expanded foam layer may provide cushioning between a surfing tether end component formed from a method of at least the present embodiment and a surfer's limb encircled thereby.

In a further embodiment, the expanded foam layer may be configured to retain a curved shape memory. In such an embodiment, the method may further comprise the step of thermally moulding the expanded foam layer so as to thermally set the curved shape memory thereinto, with this step being executed prior to step 202.

In an embodiment, the surfing tether end component may not comprise adhesives, additional cross-link polymers or any other additional affixing means between the adjacent two of the one or more end component body layers, the tether connector, and the fastening means that are affixed to one another by being bonded together.

In an embodiment, the surfing tether end component may comprise a secondary element such as a puller, a buckle loop or a decorative element. In such an embodiment the method may comprise the step of arranging the secondary element adjacent to an end component body layer, with step 206 including affixing the secondary element to the end component body. This step may be executed as part of step 204 or step 205, or may be present as its own step 204A and executed at any point prior to execution of step 206. In a further embodiment, step 204A may be executed prior to step 203, such that step 203 is modified in a manner similar to previously-disclosed embodiments wherein steps 204 and/or 205 are executed prior to step 203.

### Formation Method—Moulding

A third aspect of the present invention may lie in a method of fabricating a surfing tether end component comprising an end component body having one or more end component body layers, fastening means and a tether connector, wherein at least one of the fastening means and/or the tether connector are moulded from, onto or into the end component body.

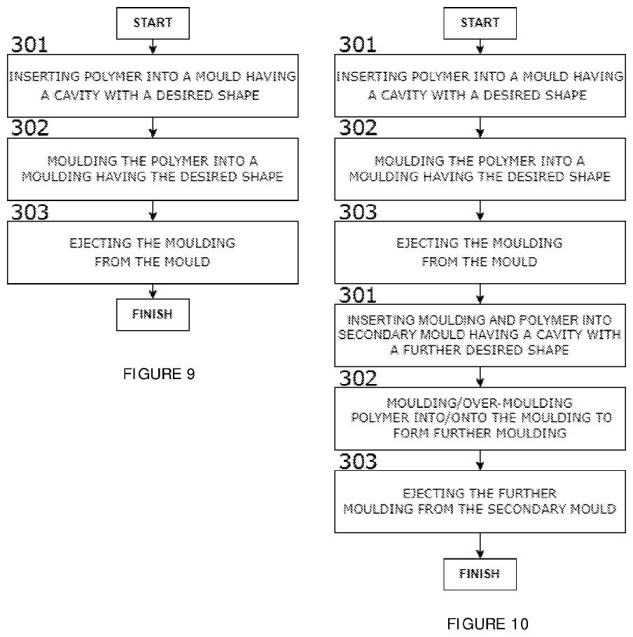

In an embodiment and with reference to FIG. 9, the method may comprise the steps of:
301) Inserting a polymer of a single polymer class into a mould having a cavity with a desired shape comprising at least one end component body layer and one or more of a tether connector, and a fastening means;
302) moulding the polymer into a moulding having the desired shape; and
303) ejecting the moulding from the mould;
   wherein the moulding comprises the at least one end component body layer and the one or more of the tether connector and fastening means having unitary construction.

In a further embodiment and with reference to FIG. 10, the method may comprise over-moulding an element onto the moulding produced by step 303. In such an embodiment, the method may further comprise the steps of:
304) inserting the moulding into a secondary mould, along with additional polymer of the single polymer class, the secondary mould having a cavity with a further desired shape comprising the moulding and a further one or more of the tether connector and fastening means, excluding those already formed as a part of the moulding;
305) moulding or over-moulding the polymer onto or into the moulding, forming a further moulding having the further desired shape; and
306) ejecting the further moulding from the secondary mould.

In a further embodiment, the surfing tether end component may comprise a secondary element such as a puller, a buckle loop or a decorative element. In such an embodiment the method may comprise use of a mould having a cavity with a desired shape, or a secondary mould having a cavity with a further desired shape, that includes the secondary element, such that the moulding or further moulding is formed to include the secondary element.

In an embodiment, the method may comprise the step of thermally bonding a cushioning layer to a surface of the moulding. The cushioning layer may be arranged to be positioned against a user's limb when the surfing tether end component is worn by the user. In a further embodiment, the cushioning layer may comprise expanded polymer foam.

In an embodiment, the moulding or further moulding may be used as an end component body layer, comprising the element moulded thereinto, onto or from, in an embodiment of a method of the second aspect of the present invention. In such an embodiment, the method of the second aspect of the invention may be appropriately modified to remove the need to affix said element to the end component body during execution of an embodiment of step 206 or an embodiment of a modified step 203.

While the invention has been described with reference to preferred embodiments above, it will be appreciated by those skilled in the art that it is not limited to those embodiments, but may be embodied in many other forms, variations and modifications other than those specifically described. The invention includes all such variation and modifications. The invention also includes all of the steps, features, elements and/or devices referred to or indicated in the specification, individually or collectively and any and all combinations or any two or more of the steps or features.

In this specification, unless the context clearly indicates otherwise, the word “comprising” is not intended to have the exclusive meaning of the word such as “consisting only of”, but rather has the non-exclusive meaning, in the sense of “including at least”. The same applies, with corresponding grammatical changes, to other forms of the word such as “comprise”, etc.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Any promises made in the present document should be understood to relate to some embodiments of the invention, and are not intended to be promises made about the invention in all embodiments. Where there are promises that are deemed to apply to all embodiments of the invention, the applicant/patentee reserves the right to later delete them from the description and they do not rely on these promises for the acceptance or subsequent grant of a patent in any country.

1-41. (canceled)

42. A surfing tether end component comprising:
an end component body having one or more end component body layers;
a tether connector for connecting the surfing tether end component to a surfing device tether; and
a fastening means;
wherein at least one adjacent pair of the end component body, the one or more layers of the end component body, the tether connector and the fastening means are at least partially affixed to one another by being welded thereto.

43. The surfing tether end component of claim 42, wherein at least a portion of at least one of the one or more end component body layers comprises at least one polymer selected from a single polymer class, being a contacting portion thereof;
at least one of the fastening means and the tether connector comprise a contacting surface comprised of at least one polymer selected from the single polymer class; and
the contacting surface contacts against and welds to the contacting portion.

44. The surfing tether end component of claim 43, wherein the weld is a molecular or intermolecular bond.

45. The surfing tether end component of claim 42, wherein the contacting surface and the contacting portion are welded together through an internal heat welding process or an external heat welding process, or through both the internal heat welding process and the external heat welding process to thermally bond the contacting surface and the contacting portion together.

46. The surfing tether end component of claim 45, wherein the weld is at least partially formed via internal heat welding process; and
the internal heat welding process is either an electromagnetic welding process or a mechanical welding process, or both the electromagnetic welding process and the mechanical welding process, are used.

47. The surfing tether end component of claim 45, wherein the weld is at least partially formed via external heat welding process; and
the external heat welding process is a thermal welding process.

48. The surfing tether end component of claim 43, wherein the single polymer class is one of the set of classes comprising thermoplastics, thermoplastic elastomers, thermosets, polypropylenes, polyketones, polyethylenes, polyurethanes, vinyls, polyolefins, or suitable derivatives thereof.

49. The surfing tether end component of claim 48, wherein the contacting portion is substantially formed from a single polymer, or wherein the contacting surface is substantially formed from the same single polymer as the contacting portion.

50. The surfing tether end component of claim 43, wherein the end component body comprises more than one end component body layer; and
the contacting portion is provided by an outermost end component body layer.

51. The surfing tether end component of claim 43, wherein the end component body comprises more than one end component body layer; and
at least one end component body layer is arranged over the end component body layer providing the contacting portion so as to enclose, within the end component body, at least a portion of the at least one of the fastening means and the tether connector having the contacting surface welded to the contacting portion.

52. The surfing tether end component of claim 42, wherein the end component body comprises more than one end component body layer, each end component body layer extending for at least a portion of a length of the end component body; and
at least two adjacent end component body layers are formed of at least one polymer selected from the single polymer class and are at least partially affixed to one another by welding.

53. The surfing tether end component of claim 42, further comprising a secondary element welded onto or into the one or more end component body layers.

54. The surfing tether end component of claim 42, being configured to attach the tether to a user's limb;
wherein the tether end component body is configured to encircle the user's limb; and
the fastening means comprises a first fastening structure and a second fastening structure arranged to releasably engage with one another when the user's limb is encircled by the tether end component body.

55. The surfing tether end component of claim 54, wherein at least one of the at least two adjacent end component body layers comprises a cushioning layer or an expanded polymer foam layer, or wherein at least one of the at least two adjacent end component body layers comprises the cushioning layer and the expanded polymer foam layer.

56. The surfing tether end component of claim 42, wherein the surfing tether end component does not comprise adhesives, additional cross-link polymers or any other additional affixing means between the adjacent two of the one or more end component body layers, the tether connector and the fastening means that are affixed to one another by being welded together.

57. A method of fabricating a surfing tether end component comprising an end component body having one or more end component body layers, a fastening means and a tether connector, comprising the steps of:
I. forming one or more end component body layers;
II. arranging the one or more end component body layers into a desired configuration to form the end component body;
III. if the end component body comprises more than one end component body layer, attaching the plurality of end component body layers together to form the end component body;
IV. arranging a tether connector adjacent to a layer of the end component body;
V. arranging a fastening means; and
VI. affixing the tether connector and fastening means to the end component body;
wherein at least one adjacent pair of the one or more end component body layers, the end component body, the tether connector and fastening means are at least partially affixed to one another by welding thereto.

58. The method of claim 57, wherein at least a portion of at least one of the one or more end component body layers comprises at least one polymer selected from a single polymer class, being a contacting portion thereof;
at least one of the fastening means and the tether connector comprise a contacting surface comprised of at least one polymer selected from the single polymer class; and
the contacting surface contacts against and welds to the contacting portion.

59. The method of claim 57, wherein the contacting surface and the contacting portion are welded together through an internal heat welding process or an external heat welding process, or both internal and external heat welding processes are used to weld the contacting surface and the contacting portion together.

60. The method of claim 59, wherein the weld is at least partially formed via internal heat welding process; and
the internal heat welding process is either an electromagnetic welding process or a mechanical welding process, or both the electromagnetic welding process and the mechanical welding process are used.

61. A surfing tether end component fabricated according to the method of claim 57.
